(19) United States
(12) Patent Application Publication
(10) Pub. No.: US 2011/0155180 A1
(43) Pub. Date: Jun. 30, 2011

(54) WAFER CLEANING APPARATUS AND WAFER CLEANING METHOD USING THE SAME

(76) Inventors: Ok-Min Moon, Gyeonggi-do (KR); Young-Bang Lee, Gyeonggi-do (KR)

(21) Appl. No.: 12/833,275

(22) Filed: Jul. 9, 2010

(30) Foreign Application Priority Data
Dec. 30, 2009 (KR) 10-2009-0134230

(51) Int. Cl. B08B 3/00

(52) U.S. Cl. 134/30; 134/105

(57) ABSTRACT

A wafer cleaning apparatus and a wafer cleaning method using the same are provided. The wafer cleaning method includes removing an oxide layer, which is formed on a wafer, by performing a dry cleaning process using hydrogen fluoride (HF) gas and ammonia (NH₃) gas, and removing a reaction by-product generated during the dry cleaning process by performing a wet cleaning process which sprays a chemical onto the wafer.

### CROSS-REFERENCE TO RELATED APPLICATION

The present application claims priority of Korean Patent Application No. 10-2009-0134230, filed on Dec. 30, 2009, which is incorporated herein by reference in its entirety.

### BACKGROUND OF THE INVENTION

Exemplary embodiments of the present invention relate to a semiconductor device fabrication technology, and more particularly, to a wafer cleaning apparatus and a wafer cleaning method using the same.

As the integration density of a semiconductor device has increased, a low-selectivity cleaning method has been required. Thus, instead of a wet cleaning, a dry cleaning is widely applied to a semiconductor fabrication process.

FIGS. 1A to 1C illustrate a conventional wafer cleaning apparatus. Specifically, FIG. 1A is an image showing an entire construction of a wafer cleaning apparatus, FIG. 1B is a detailed cross-sectional view illustrating a chemical oxide removal (COR) chamber of FIG. 1A, and FIG. 1C is a detailed cross-sectional view illustrating a post heating treatment (PHT) chamber of FIG. 1A.

A conventional wafer cleaning apparatus is described below with reference to FIGS. 1A to 1C. The conventional wafer cleaning apparatus includes a COR chamber 10 and a PHT chamber 20. The COR chamber 10 removes a cleaning target layer, for example, an oxide layer 101, from a wafer 100 by reacting the oxide layer 101 with a cleaning gas. The PHT chamber 20 removes a reaction by-product generated in the COR chamber 10 by using heat. The COR chamber 10 includes a chuck 13 configured to support the wafer 100, a gas injection port 11 through which a cleaning gas is injected, and a gas exhaust port 12. The PHT chamber 20 includes a gas exhaust port 22 and a chuck 23 configured to support the wafer 100. A heater configured to heat the wafer 100 is provided inside the chuck 23.

A wafer cleaning method using the wafer cleaning apparatus having the above-described construction is described below.

First, the wafer 100 on which a cleaning target layer, for example, an oxide layer 101, is formed is transferred into the COR chamber 10 and fixed to the chuck 13. Then, the cleaning gas is injected through the gas injection port 11. Due to the reaction between the injected cleaning gas and the oxide layer 101, the reaction by-product R remains on the wafer 100 while the oxide layer 101 is being removed.

Next, the wafer 100 on which the reaction by-product R remains is transferred into the PHT chamber 20 and fixed to the chuck 23. Then, the reaction by-product R is removed by heating the wafer 100 at a high temperature.

However, the conventional wafer cleaning method must pass through the COR chamber 10 and the PHT chamber 20 in order to remove the reaction by-product R. Consequently, the fabrication time increases, and thus, productivity decreases.

Furthermore, since the PHT chamber 20 removes the reaction by-product R by heating the wafer 100, a thermal stabilization time is additionally required. Therefore, the fabrication time further increases, and the productivity further decreases.

Moreover, in order to remove the reaction by-product R by using heat, the PHT chamber 20 must heat the wafer 100 to at least 100° C. or higher (100° C. to 400° C.). Typically, the PHT chamber 20 heats the wafer 100 to approximately 300° C. Accordingly, the wafer 100 may be damaged by the high temperature.

### SUMMARY OF THE INVENTION

Exemplary embodiments of the present invention are directed to a wafer cleaning apparatus, which is capable of removing a reaction by-product generated during a dry cleaning process, without heating the wafer to a high temperature, and a wafer cleaning method using the same.

Another exemplary embodiment of the present invention is directed to a wafer cleaning apparatus, which is capable of reducing a wafer cleaning process time, and a wafer cleaning method using the same.

In accordance with an exemplary embodiment of the present invention, a wafer cleaning method includes removing an oxide layer, which is formed on a wafer, by performing a dry cleaning process using hydrogen fluoride (HF) gas and ammonia (NH3) gas, and removing a reaction by-product generated during the dry cleaning process by performing a wet cleaning process which sprays a chemical onto the wafer. The oxide layer may include a silicon oxide (SiO₂) layer.

The dry cleaning process may be performed by heating the wafer in a chamber having an atmosphere with a temperature in a range of approximately 10° C. to approximately 40° C.

The wet cleaning process may be performed by spraying a heated chemical onto the wafer. Also, the wet cleaning process may be performed by heating the wafer while spraying the chemical onto the wafer.

The chemical may include any one selected from the group consisting of sulfuric acid-peroxide mixture (SPM), ammonium hydroxide peroxide mixture (APM), deionized water, and a mixed solution thereof.

The wet cleaning process using the SPM may be performed, so that the SPM is heated to a temperature in a range of approximately 90° C. to approximately 120° C. The wet cleaning process using the APM or the deionized water may be performed, so that the APM or the deionized water is heated to a temperature in a range of approximately 20° C. to approximately 80° C.

The dry cleaning process and the wet cleaning process may be performed in-situ within a same chamber. Alternatively, the dry cleaning process and the wet cleaning process may be performed within a dry cleaning chamber and a wet cleaning chamber, respectively.

In accordance with another exemplary embodiment of the present invention, a wafer cleaning apparatus includes a dry cleaning chamber, and a wet cleaning chamber coupled to the dry cleaning chamber and including a heating unit and a chemical spray nozzle.

The dry cleaning chamber may include a chuck configured to support a wafer, a gas injection port, a gas exhaust port, and a heater provided inside the chuck. The dry cleaning chamber may include a plurality of gas injection ports, depending on a type of cleaning gas used or if a number of cleaning gasses are used.

The wet cleaning chamber may further include a rotating chuck configured to support and spin the wafer, and a chemical exhaust port. The heating unit may include a heater provided inside the rotating chuck.

The wet cleaning chamber may include a plurality of chemical spray nozzles, depending on a type of cleaning solution used or if a number of cleaning solutions are used.

In accordance with yet another exemplary embodiment of the present invention, a wafer cleaning apparatus includes a cleaning chamber, wherein the cleaning chamber includes a gas injection port for use in performing a dry cleaning process, a chemical spray nozzle for use in performing a wet cleaning process, and a heating unit. The cleaning chamber may further include a rotating chuck configured to support and spin a wafer, and an exhaust port through which a gas and a chemical are exhausted.

The heating unit may include a heater provided inside the rotating chuck.

The cleaning chamber may include a plurality of gas injection ports, depending on a type of cleaning gas used or if a number of cleaning gases are used.

The cleaning chamber may include a plurality of chemical spray nozzles, depending on a type of cleaning solution used or if a number of cleaning solutions are used.

### BRIEF DESCRIPTION OF THE DRAWINGS

FIGS. 1A to 1C illustrate a conventional wafer cleaning apparatus.

FIGS. 2A to 2C illustrate a wafer cleaning apparatus in accordance with a first exemplary embodiment of the present invention.

FIG. 3 is a cross-sectional view illustrating a wafer cleaning apparatus in accordance with a second exemplary embodiment of the present invention.

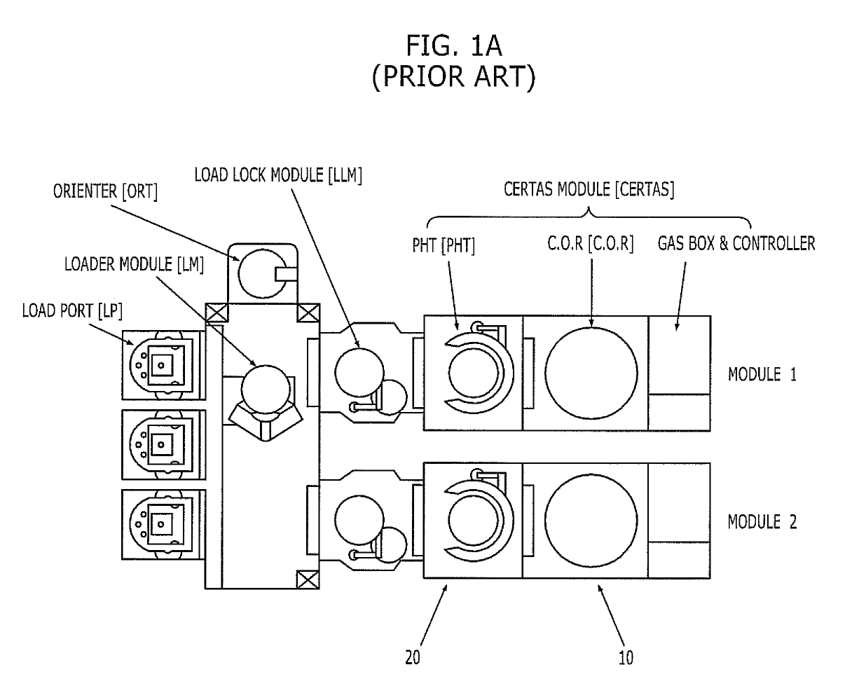

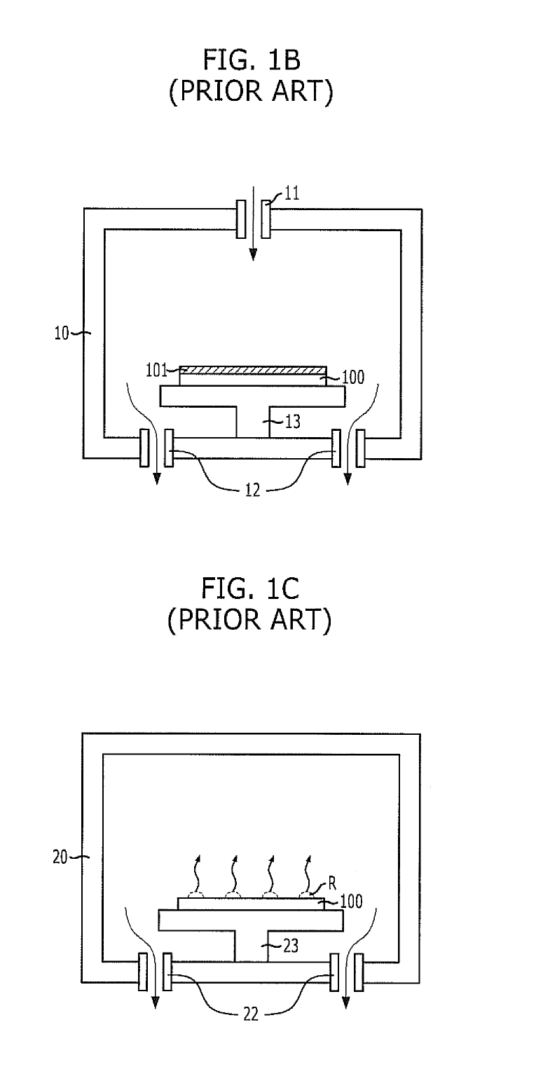

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention are directed to a wafer cleaning apparatus, which is capable of removing a reaction by-product generated during a dry cleaning process, without heating the wafer to a high temperature, and a wafer cleaning method using the same. To this end, a dry cleaning process is performed to remove a cleaning target layer remaining on a wafer, and a wet cleaning process is then performed to remove a reaction by-product generated during the dry cleaning process.

Hereinafter, a wafer cleaning apparatus capable of sequentially performing a dry cleaning process and a wet cleaning process is described. Also, a wafer cleaning method using the wafer cleaning apparatus is described.

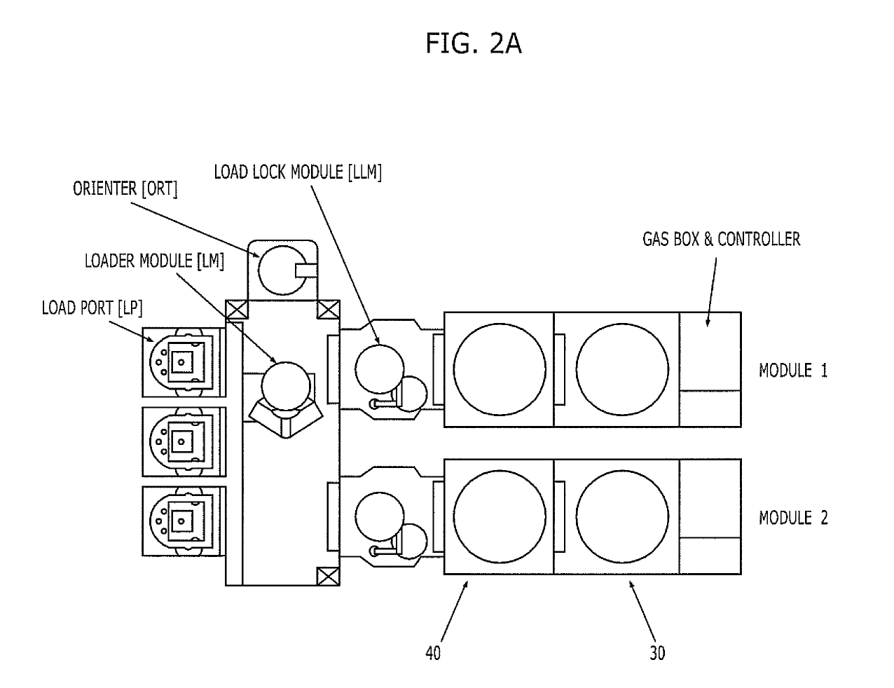

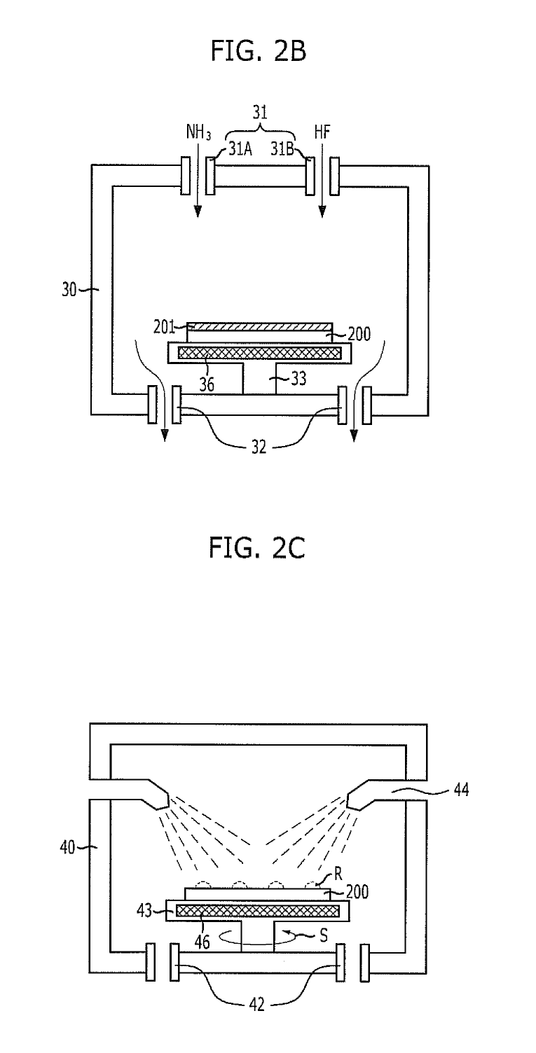

FIGS. 2A to 2C illustrate a wafer cleaning apparatus in accordance with a first exemplary embodiment of the present invention. Specifically, FIG. 2A is an image showing a construction of a wafer cleaning apparatus, FIG. 2B is a cross-sectional view illustrating a dry cleaning chamber of FIG. 2A, and FIG. 2C is a cross-sectional view illustrating a wet cleaning chamber of FIG. 2A.

Referring to FIGS. 2A to 2C, the wafer cleaning apparatus in accordance with the first exemplary embodiment of the present invention includes a dry cleaning chamber 30 and a wet cleaning chamber 40. The wet cleaning chamber 40 is coupled to the dry cleaning chamber 30 and includes a heating unit and a chemical spray nozzle 44.

The dry cleaning chamber 30 may include a chuck 33 configured to support a wafer 200 having a cleaning target layer 201 formed thereon, a heater 36 provided inside the chuck 33 and configured to heat the wafer 200, a gas injection port 31 through which a cleaning gas is injected, and a gas exhaust port 32 through which an unreacted cleaning gas or the like is exhausted. As shown in FIG. 2B, a plurality of gas injection ports 31 may be provided depending on the type of cleaning gas used or if a number of cleaning gases are injected into the dry cleaning chamber 30.

The wet cleaning chamber 40 may include a rotating chuck 43 configured to support and spin the wafer 200, a heater 46 provided inside the rotating chuck 43 as the heating unit, an exhaust port 42 through which an unreacted cleaning solution or the like is exhausted, and a chemical spray nozzle 44. As shown in FIG. 2C, a plurality of chemical spray nozzles 44 may be provided depending on the type of cleaning solution used or if a number of cleaning solutions are injected into the wet cleaning chamber 40. Further, instead of or in addition to the heater 46, the wet cleaning chamber 40 may include a heating unit (not shown in FIG. 2C) that is configured to heat a chemical provided by the chemical spray nozzle 44. Also, although a plurality of exhaust ports 42 are shown in FIG. 2C, the wet cleaning chamber may have only one exhaust port 42, and therefore, may require only one pump for exhausting a vaporized reaction by-product and/or unreacted cleaning solution.

Hereinafter, a wafer cleaning method using the wafer cleaning apparatus in accordance with the first exemplary embodiment of the present invention is described. Specifically, a case in which the cleaning target layer 201 is an oxide layer (e.g., a silicon oxide (SiO₂) layer) formed on the wafer 200 is exemplified.

First, the wafer 200, on which the oxide layer 201 is formed, is transferred into the dry cleaning chamber 30 and fixed to the chuck 33. Then, the cleaning gas is injected through the gas injection port 31. Ammonia (NH₃) gas and hydrogen fluoride (HF) gas may be used as the cleaning gas. As shown in FIG. 2B, the respective cleaning gases may be injected through different gas injection ports 31A and 31B. That is, the ammonia gas may be injected through a first injection port 31A, and the hydrogen fluoride gas may be injected through a second injection port 31B.

Next, the oxide layer 201 is removed by reacting the oxide layer 201 with the cleaning gas injected into the dry cleaning chamber 30. The reaction between the cleaning gas and the oxide layer 201 may be expressed as chemical formula 1 below.

SiO₂(g)+4HF(g)→SiF₄(g)+2H₂O(g)

SiF₄(g)+2NH₃(g)+2HF(g)→(NH₄)₂SiF₆(s) Chemical Formula 1

As expressed in chemical formula 1, the oxide layer 201 is removed as a result of its reaction with the cleaning gas, and (NH₄)₂SiF₆ is generated as a reaction by-product (labeled as ‘R’ in FIG. 2C). At this time, in order to improve the reaction between the cleaning gas and the oxide layer 201, the dry cleaning process may be performed by heating the wafer 200 in a chamber having an atmosphere with a temperature in the range of approximately 10° C. to approximately 40° C.

The reaction by-product R generated during the dry cleaning process remains on the wafer 200 in a solid state, and the reaction by-product R cannot be removed by the cleaning gas injected into the dry cleaning chamber 30.

Therefore, in order to remove the reaction by-product R, the wafer 200 is transferred into the wet cleaning chamber 40 and fixed to the rotating chuck 43. Then, the reaction by-product R is removed by spraying a chemical onto the wafer 200 through the chemical spray nozzle 44, while spinning the rotating chuck 43. The chemical may be one or more materials selected from the group consisting of sulfuric acid-peroxide mixture (SPM), ammonium hydroxide peroxide mixture (APM), and deionized water (H₂O, DI).

In order to increase the efficiency of removing the reaction by-product R, when SPM is used as the chemical, the wet cleaning process may be performed by heating the wafer 200, so that the SPM is heated to a temperature in the range of approximately 90° C. to approximately 120° C. When APM or DI water is used as the chemical, the wet cleaning process may be performed by heating the wafer 200, so that the APM or DI water is heated to a temperature in the range of approximately 20° C. to approximately 80° C. Also, the efficiency of removal of the reaction by-product R may be improved by heating the chemical to a certain temperature and spraying the heated chemical onto the wafer 200 through the chemical spray nozzle 44.

For reference, SPM is a mixed solution in which sulfuric acid (H₂SO₄), peroxide (H₂O₂), and deionized water (H₂O, DI) are mixed together, and APM is a mixed solution in which ammonium hydroxide (NH₄OH), peroxide, and deionized water are mixed together.

As opposed to the PHT chamber which uses a high temperature (approximately 300° C.) in order to remove the reaction by-product R generated during the dry cleaning process, the wafer cleaning apparatus and the wafer cleaning method using the same in accordance with an exemplary embodiment of the present invention do not require a thermal stabilization time, and therefore, the reaction by-product R can be removed in a shorter period of time. It is possible for the wafer cleaning apparatus in accordance with an exemplary embodiment of the present invention to remove the reaction by-product R in approximately 1 minute. Moreover, an additional pump for exhausting a vaporized reaction by-product R to the outside of the chamber is not required.

As such, the wafer cleaning apparatus and the wafer cleaning method using the same in accordance with an exemplary embodiment of the present invention can reduce the fabrication time due to the reduced wafer cleaning time, and thus, improve the productivity. Furthermore, since it is unnecessary to heat the wafer 200 to a high temperature, it is possible to prevent the wafer 200 from being damaged by the high temperature.

A second exemplary embodiment of the present invention is directed to provide a wafer cleaning apparatus and a wafer cleaning method using the same, which are capable of simplifying the construction and cleaning process. To this end, the second exemplary embodiment of the present invention provides a wafer cleaning apparatus having a construction in which a dry cleaning chamber 30 and a wet cleaning chamber 40 are combined into a single cleaning chamber.

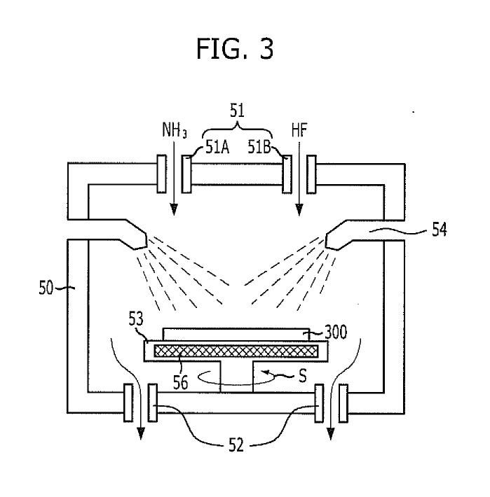

FIG. 3 is a cross-sectional view illustrating a wafer cleaning apparatus in accordance with a second exemplary embodiment of the present invention.

Referring to FIG. 3, the wafer cleaning apparatus in accordance with the second exemplary embodiment of the present invention includes a cleaning chamber 50, a gas injection port 51 through which a cleaning gas for a dry cleaning process is injected, a chemical spray nozzle 54 through which a chemical for a wet cleaning process is sprayed, a rotating chuck 53 configured to support and spin a wafer 300, a heater 56 provided inside the rotating chuck 53, and an exhaust port 52 through which unreacted gas or unreacted chemical is exhausted from the chamber 50.

A plurality of gas injection ports 51 may be provided depending on the type of cleaning gas used or if a number of cleaning gases are injected into the cleaning chamber 50, and a plurality of chemical spray nozzles 44 may be provided depending on the type of cleaning solution used or if a number of cleaning solutions are injected into the cleaning chamber 50.

According to the wafer cleaning method using the wafer cleaning apparatus having the above-described construction, the wafer 300 is loaded into the cleaning chamber 50 and fixed to the rotating chuck 53. Subsequently, the cleaning gas is injected through the gas injection port 51 and the dry cleaning process is performed on the wafer 300. Subsequently, the reaction by-product R generated during the dry cleaning process is removed by spraying the chemical onto the wafer 300 through the chemical spray nozzle 54, while spinning the rotating chuck 53.

In the wafer cleaning apparatus in accordance with the second exemplary embodiment of the present invention, the wafer 300 need not be moved between the chambers because the dry cleaning process for cleaning the cleaning target layer (not shown in FIG. 3) and the wet cleaning process for removing the reaction by-product generated during the dry cleaning process (also not shown in FIG. 3) are performed in-situ within the single cleaning chamber 50. Hence, the cleaning time can be further reduced than that of the wafer cleaning apparatus in accordance with the first exemplary embodiment of the present invention. Consequently, the fabrication time can be further reduced, and thus, productivity can be further improved.

The use of the wafer cleaning apparatuses in accordance with the first and second exemplary embodiments of the present invention can improve the uniformity of the cleaning target layer when the cleaning process is completed. Tables 1 to 4 below show the variations in the thickness of the oxide layer after the cleaning process is performed on the oxide layer by using the wafer cleaning apparatuses in accordance with the prior art and the first and second exemplary embodiments of the present invention.

TABLE 1
Prior Art

| Classification (Unit: Å) | Before Cleaning | After Cleaning |
|---|---|---|
| Maximum Value | 56.57 | 13.94 |
| Minimum Value | 55.98 | 11.07 |
| Mean Value | 56.31 | 12.58 |
| Variation (Uniformity) | 0.59 | 2.87 |

TABLE 2
Embodiment (Dry Cleaning + SPM Wet Cleaning)

| | Before | | Wet Cleaning |
|---|---|---|---|
| Classification (Unit: Å) | Cleaning | Dry Cleaning | (SPM) |
| Maximum Value | 56.30 | 148.94 | 16.19 |
| Minimum Value | 55.70 | 144.40 | 13.69 |
| Mean Value | 55.96 | 146.65 | 14.67 |
| Variation (Uniformity) | 0.60 | 4.53 | 2.50 |

TABLE 3
Embodiment (Dry Cleaning + APM Wet Cleaning)

| | Before | | Wet Cleaning |
|---|---|---|---|
| Classification (Unit: Å) | Cleaning | Dry Cleaning | (SPM) |
| Maximum Value | 56.67 | 150.82 | 13.86 |
| Minimum Value | 56.11 | 146.31 | 12.83 |
| Mean Value | 56.36 | 148.57 | 13.50 |
| Variation (Uniformity) | 0.57 | 4.51 | 1.03 |

TABLE 4
Embodiment (Dry Cleaning + DI Water Wet Cleaning)

| | Before | | Wet Cleaning |
|---|---|---|---|
| Classification (Unit: Å) | Cleaning | Dry Cleaning | (SPM) |
| Maximum Value | 56.85 | 156.96 | 17.42 |
| Minimum Value | 56.20 | 145.65 | 14.96 |
| Mean Value | 56.57 | 151.29 | 15.98 |
| Variation (Uniformity) | 0.65 | 11.31 | 2.46 |

As can be seen from Tables 1 to 4 above, while the thickness difference (uniformity) of the oxide layer remaining on the entire wafer was 2.87 Å when the cleaning process was performed on the oxide layer by using the conventional wafer cleaning apparatus, the thickness difference of the oxide layer remaining on the entire wafer was 2.5 Å, 10.3 Å, and 2.46 Å, depending on the chemicals used in the wet cleaning process, when the cleaning process was performed on the oxide layer by using the wafer cleaning apparatuses in accordance with the first and second exemplary embodiments of the present invention. Consequently, it can be seen that the uniformity may be improved as compared to the prior art.

In accordance with the exemplary embodiments of the present invention, since the reaction by-product generated during the dry cleaning process is removed through the wet cleaning process, the thermal stabilization time is not required, as opposed to the PHT chamber of the conventional wafer cleaning apparatus. Furthermore, the reaction by-product can be removed in a short time, for example, approximately 1 minute. Hence, the fabrication time can be reduced and productivity can be improved. Moreover, it is possible to prevent the wafer from being damaged by the high temperature (for example, approximately 300° C.).

In addition, it is possible to improve the uniformity of the cleaning target layer remaining after the cleaning process is completed.

Furthermore, since an additional pump for exhausting the vaporized reaction by-product to the outside of the chamber is not required, the construction of the wafer cleaning apparatus can be simplified.

While the present invention has been described with respect to the specific embodiments, it will be apparent to those skilled in the art that various changes and modifications may be made without departing from the spirit and scope of the invention as defined in the following claims.

What is claimed is:

1. A wafer cleaning method comprising:
removing an oxide layer, which is formed on a wafer, by performing a dry cleaning process using hydrogen fluoride (HF) gas and ammonia (NH₃) gas; and
removing a reaction by-product generated during the dry cleaning process by performing a wet cleaning process which sprays a chemical onto the wafer.

2. The wafer cleaning method of claim 1, wherein the oxide layer comprises a silicon oxide (SiO₂) layer.

3. The wafer cleaning method of claim 1, wherein the dry cleaning process is performed by heating the wafer in a chamber having an atmosphere with a temperature in a range of approximately 10° C. to approximately 40° C.

4. The wafer cleaning method of claim 1, wherein the wet cleaning process is performed by spraying a heated chemical onto the wafer.

5. The wafer cleaning method of claim 1, wherein the wet cleaning process is performed by heating the wafer while spraying the chemical onto the wafer.

6. The wafer cleaning method of claim 5, wherein the chemical comprises any one selected from the group consisting of sulfuric acid-peroxide mixture (SPM), ammonium hydroxide peroxide mixture (APM), deionized water, and a mixed solution thereof.

7. The wafer cleaning method of claim 6, wherein the wet cleaning process using the SPM is performed, so that the SPM is heated to a temperature in a range of approximately 90° C. to approximately 120° C.

8. The wafer cleaning method of claim 6, wherein the wet cleaning process using the APM or the deionized water is performed, so that the APM or the deionized water is heated to a temperature in a range of approximately 20° C. to approximately 80° C.

9. The wafer cleaning method of claim 1, wherein the dry cleaning process and the wet cleaning process are performed in-situ within a same chamber.

10. The wafer cleaning method of claim 1, wherein the dry cleaning process and the wet cleaning process are performed within a dry cleaning chamber and a wet cleaning chamber, respectively.

11. A wafer cleaning apparatus comprising:
a dry cleaning chamber; and
a wet cleaning chamber coupled to the dry cleaning chamber and comprising a heating unit and a chemical spray nozzle.

12. The wafer cleaning apparatus of claim 11, wherein the dry cleaning chamber comprises a chuck configured to support a wafer, a gas injection port, a gas exhaust port, and a heater provided inside the chuck.

13. The wafer cleaning apparatus of claim 11, wherein the dry cleaning chamber comprises a plurality of gas injection ports, depending on a type of cleaning gas used or if a number of cleaning gases are used.

14. The wafer cleaning apparatus of claim 11, wherein the wet cleaning chamber further comprises a rotating chuck configured to support and spin the wafer, and a chemical exhaust port.

15. The wafer cleaning apparatus of claim 14, wherein the heating unit comprises a heater provided inside the rotating chuck.

16. The wafer cleaning apparatus of claim 11, wherein the wet cleaning chamber comprises a plurality of chemical spray nozzles, depending on a type of cleaning solution used or if a number of cleaning solutions are used.

17. A wafer cleaning apparatus comprising:
a cleaning chamber, wherein the cleaning chamber comprises:
a gas injection port for use in performing a dry cleaning process;
a chemical spray nozzle for use in performing a wet cleaning process; and
a heating unit.

18. The wafer cleaning apparatus of claim 17, wherein the cleaning chamber further comprises:
a rotating chuck configured to support and spin a wafer; and
an exhaust port through which a gas and a chemical are exhausted.

19. The wafer cleaning apparatus of claim 18, wherein the heating unit comprises a heater provided inside the rotating chuck.

20. The wafer cleaning apparatus of claim 17, wherein the cleaning chamber comprises a plurality of gas injection ports, depending on a type of cleaning gas used or if a number of cleaning gases are used.

21. The wafer cleaning apparatus of claim 17, wherein the cleaning chamber comprises a plurality of chemical spray nozzles, depending on a type of cleaning solution used or if a number of cleaning solutions are used.
